(19) United States
(12) Patent Application Publication
(10) Pub. No.: US 2018/0283212 A1
(43) Pub. Date: Oct. 4, 2018

(54) SYSTEM AND METHOD FOR ATTACHING A NON-METAL COMPONENT TO A METAL COMPONENT

(71) Applicant: Siemens Energy, Inc., Orlando, FL (US)

(72) Inventor: David J. Wiebe, Orlando, FL (US)

(21) Appl. No.: 15/765,739

(22) PCT Filed: Oct. 30, 2015
(86) PCT No.: PCT/US2015/058196

§ 371 Date: Apr. 4, 2018

(51) Int. Cl. F01D 25/24; F01D 25/00; F01D 9/02; F01D 25/26; F01D 25/12

(52) U.S. Cl. CPC F01D 25/243; F01D 25/005; F01D 9/023; F01D 25/26; F05D 2230/60; F05D 2300/6033; F05D 2300/50212; F05D 2260/20; F01D 25/12

(57) ABSTRACT

There are provided systems and processes for attaching a non-metal component comprising a ceramic matrix composite material, such as a transition duct, to a metal component, such as a mating flange of an individual exit piece for a gas turbine. The systems and processes accommodate the differences in the thermal expansion rate of the components, as well as provide connection structures which avoids interlaminar shear of the ceramic matrix composite material by loading the ceramic matrix composite material in compression and eliminating bending forces on the ceramic matrix composite material.

### STATEMENT REGARDING FEDERALLY SPONSORED DEVELOPMENT

Development for this invention was supported in part by Contract No. DE-FE0023955, awarded by the United States Department of Energy. Accordingly, the United States Government may have certain rights in this invention.

### FIELD OF THE INVENTION

The present invention is directed to gas turbine engines, and more particularly to a system and process for securing a non-metal component comprising a ceramic matrix composite (CMC) material to a metal component.

### BACKGROUND OF THE INVENTION

In conventional gas turbine engine 5, as shown in FIG. 1, combustion gases formed within a combustor 10 are passed to a turbine assembly via a plurality of transition ducts 12. A row of first stage vanes 14 are used to turn the combustion exhaust gases before passing the exhaust gases to the row one turbine blades 16. In certain combustor designs, each transition duct is placed between the combustor 10 and an individual exit piece (IEP) that mounts on the turbine casing. The transition duct typically has a conical shape where it mounts to the IEP. Each transition duct 12 is also typically cooled if it is to be made of metal, a situation that decreases engine efficiency and increases NOx. An increase in engine efficiency can be realized if the transition duct were made of a higher temperature material, such as a ceramic matrix composite (CMC) material that would not require cooling. One problem, however, with a transition duct formed from CMC material is the CMC material has a relatively low interlaminar strength which, along with a difference in thermal expansion, renders a mechanical joint with the metallic individual exit piece difficult.

### BRIEF DESCRIPTION OF THE DRAWINGS

The invention is explained in the following description in view of the drawings that show:

FIG. 1 is a schematic of a known gas turbine engine.

FIG. 2 is a cross-sectional view of a system for securing a non-metal component to a metal component in accordance with an aspect of the present invention.

FIG. 3 illustrates a non-metal transition duct secured to a metal mating flange of an Individual Exit Piece (IEP) in accordance with an aspect of the present invention.

FIG. 4 illustrates a system for securing a non-metal component to a metal component in accordance with another aspect of the present invention.

FIG. 5 illustrates a bolt having a cooling channel therein in accordance with another aspect of the present invention.

FIG. 6 illustrates a system for securing a non-metal component to a metal component in accordance with another aspect of the present invention.

FIG. 7 illustrates a non-metal transition duct secured to a metal mating flange of an Individual Exit Piece (IEP) in accordance with another aspect of the present invention.

FIG. 8 illustrates the staggered attachment of a non-metal component to a metal component in accordance with an aspect of the present invention.

FIG. 9 illustrates a plurality of first segments about a circumference of the non-metal component in accordance with an aspect of the present invention.

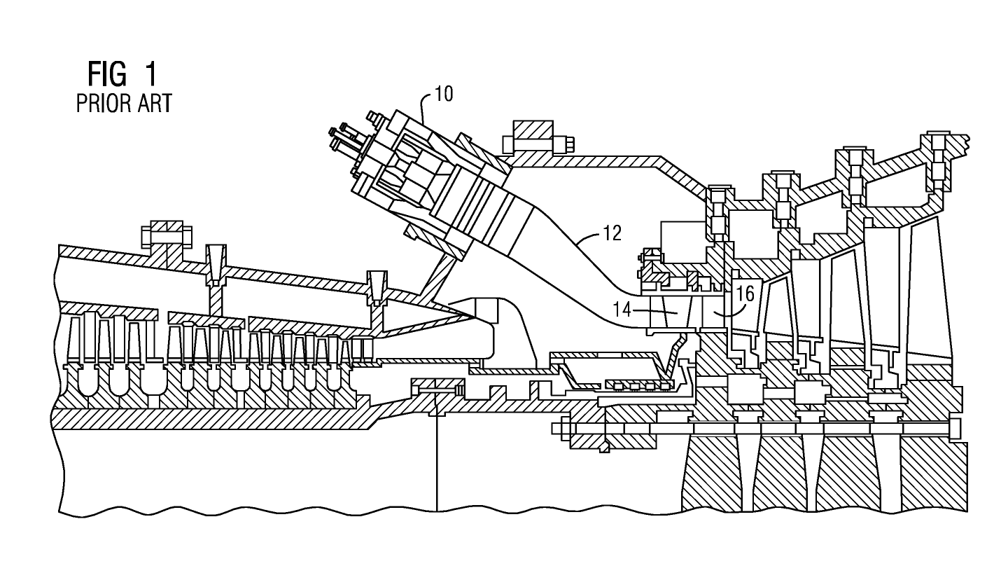

### DETAILED DESCRIPTION OF THE INVENTION

Aspects of the present invention are directed to systems and processes for securing a non-metal component comprising a CMC material to a metal component, particularly for components to be utilized in high temperature environments, e.g., within a gas turbine. To accomplish this, aspects of the present invention provide for connection structures and processes which account for the substantial differences in the thermal expansion rate of the materials. CMC materials, for example, have a much lower rate of thermal expansion than a corresponding metal material. Also, in the case of a non-metal material, such as a CMC material, aspects of the present invention provide for connection systems that direct loads on the CMC material in a manner consistent with the strength of the CMC material. CMC materials are typically strong in the plane of fiber lay-up and in compression, and thus embodiments described herein direct loads in such directions. On the other hand, CMC materials are prone to inter-laminar shear and tension, which may separate the layers thereof. Embodiments described herein reduce interlaminar shear by providing connection structures that attach a metal component to a non-metal component comprising a CMC material while avoiding bending forces on the CMC material. By way of example only, embodiments described herein may be suitable for attaching a CMC transition duct in a gas turbine engine to a mating flange on an Individual Exit Piece (IEP).

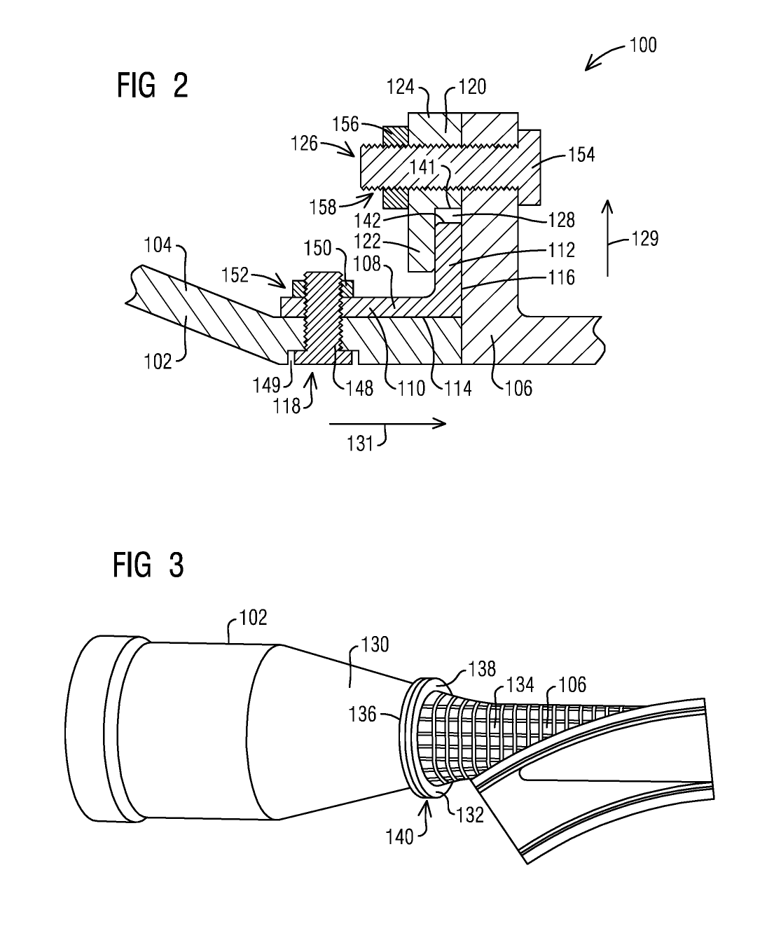

Now referring to the Figures, FIG. 2 is directed to a system 100 for securing a non-metal component 102 comprising a CMC material 104 to a metal component 106. The system 100 may be employed within a gas turbine engine 5 as described above. For ease of explanation, FIG. 2 represents a cross-sectional view of the system 100. It is appreciated, however, that the components of the system 100 may have any suitable desired shape, such as a cylindrical or polygonal shape. In the embodiment shown, the system 100 comprises the non-metal component 102, the metal component 106, a first segment 108, and a second segment 120. The first segment 108 may comprise a base portion 110 and a first extent 112 extending from the base portion 110. The second segment 120 may comprise a locking flange 122 extending from a body 124 thereof. In an embodiment, the base portion 110 may be arranged to abut a surface 114 of the non-metal component 102 and while the first extent 112 may be arranged to abut a surface 116 of the metal component 106. A first fastening device 118 may be provided and arranged to secure the base portion 110 to the non-metal component 102. In certain embodiments, the securement of the base portion 110 to the non-metal component 102 may be effective to load the CMC material 104 in compression, thereby substantially reducing or eliminating the likelihood of interlaminar shear or tension with the CMC material 104 of the non-metal component 102.

In one aspect, the first extent 112 of the first segment 108 may be arranged between the locking flange 122 of the second segment 120 and the metal component 106. A second fastening device 126 may be provided to secure the first extent 112 between the locking flange 122 of the second segment 120 and the metal component 106. Further, a radial gap 128 may be disposed between (a) a distal end 142 of the first extent 112 of the first segment 108 and (b) a bottom portion 141 of the second segment 120 in a radial direction 129 to accommodate different rates of thermal expansion rates between the non-metal and metal components 102, 106 as will be described in further detail below.

The non-metal component 102 and the metal component 106 may be of any suitable size, shape, and dimension. In an embodiment, referring to FIG. 3, the non-metal component 102 may comprise a transition duct 130 for a gas turbine as is known in the art. On the other hand, the metal component 106 may comprise a mating flange 132 of an Individual Exit Piece (IEP) 134 as is known in the art, which is configured to interface with the transition duct 130. In an embodiment and as shown, each component may have complementary cylindrical-shaped portions 136, 138 at an interface 140 of the non-metal component 102 and metal component 106, although it is understood that the present is not so limited. The shape of the components to be secured to one another, however, is not so limited, and in further embodiments may comprise a pair of flat plates or the like. In certain embodiments, the components 102, 106 may comprise a polygonal shape at the interface 140 of the components. The attachment systems as described herein may be located at one or more locations about a circumference of the components.

By way of example, the metal component 106 may comprise a Fe-based alloy, a Ni-based alloy, a Co-based alloy as are well known in the art. In certain embodiments, the alloy may comprise a superalloy. The term “superalloy” may be understood to refer to a highly corrosion-resistant and oxidation-resistant alloy that exhibits excellent mechanical strength and resistance to creep even at high temperatures. Exemplary superalloy materials are commercially available and are sold under the trademarks and brand names Hastelloy, Inconel alloys (e.g., IN 738, IN 792, IN 939), Rene alloys (e.g. Rene N5, Rene 41, Rene 80, Rene 108, Rene 142, Rene 220), Haynes alloys, Mar M, CM 247, CM 247 LC, C263, 718, X-750, ECY 768, 262, X45, PWA 1483 and CMSX (e.g. CMSX-4) single crystal alloys, GTD 111, GTD 222, MGA 1400, MGA 2400, PSM 116, CMSX-8, CMSX-10, PWA 1484, IN 713C, Mar-M-200, PWA 1480, IN 100, IN 700, Udimet 600, Udimet 500 and titanium aluminide, for example.

The CMC material 104 of the non-metal component may comprise any suitable ceramic matrix composite material that hosts a plurality of reinforcing fibers as is known in the art. In certain embodiments, the CMC material 104 may be anisotropic, at least in the sense that it can have different strength characteristics in different directions. It is appreciated that various factors, including material selection and fiber orientation can affect the strength characteristics of a CMC material. In addition, the CMC material 104 may comprise oxide as well as non-oxide CMC materials.

In a particular embodiment, the CMC material 104 may comprise alumina, and the fibers may comprise an aluminosilicate composition consisting of approximately 70% alumina; 28% silica; and 2% boron (sold under the name NEXTEL™ 312). The fibers may be provided in various forms, such as a woven fabric, blankets, unidirectional tapes, and mats. A variety of techniques are known in the art for making a CMC material and such techniques can be used in forming the CMC material 104 for use herein. In addition, exemplary CMC materials 104 are described in U.S. Pat. Nos. 8,058,191, 7,745,022, 7,153,096; 7,093,359; and 6,733,907, the entirety of each of which is hereby incorporated by reference. As mentioned, the selection of materials may not be the only factor which governs the properties of the CMC material 104 as the fiber direction may also influence the mechanical strength of the material, for example. As such, the fibers for the CMC material 104 may have any suitable orientation, such as those described in U.S. Pat. No. 7,153,096.

The first segment 108 may be formed from any suitable relatively rigid material such as a metal material as described herein. Within the first segment 108, the first extent 112 may extend from the base portion 110 of the first segment 108 at an angle thereto such that the first extent 108 and the base portion 110 are not co-linear. In an embodiment, the first extent 108 may extend radially outward at an angle of between about 45 to 90 degrees relative to the base portion 110. In a particular embodiment, as shown in FIG. 2, the first extent 112 may extend at angle perpendicular to the base portion 110. In this way, the first segment 108 may comprise an L-shaped member in certain embodiments.

The first extent 112 has a length sufficient for the first extent 112 to be grasped by the locking flange 122 of the second segment 120. In addition, the first extent 112 may be sized so as to leave the radial gap 128 between a distal end 142 of the first extent 112 and a bottom portion 141 of the second segment 120 as was shown in FIG. 2. Also, the radial gap 128 may be said to be defined between the locking flange 122 and the metal component 106 in an axial direction 131. In one aspect, the radial gap 128 allows for movement or adjustment of the position of the non-metal component 102 relative to the metal component 106. For example, at high temperatures associated with the operation of a gas turbine, hot gas may cause the metal component 106 to expand/grow at a much greater rate than the non-metal component 102 (e.g., one formed from CMC material 104). In this instance, the presence of the radial gap 128 may be effective to allow the first extent 112 to travel up and further into the radial gap 128 to accommodate a degree of thermal expansion. In accordance with one aspect, the radial gap 128 may have a dimension of about 0.15 inches or less.

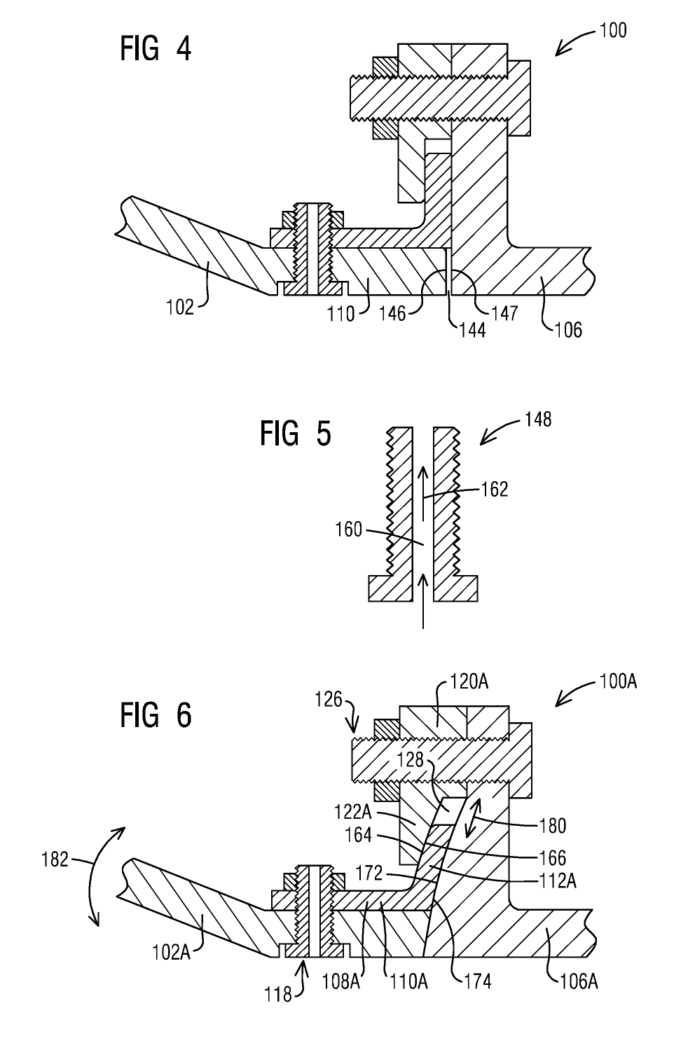

In accordance with another aspect, as shown in FIG. 4, there may further be disposed an axial gap 144 disposed between a distal edge 146 of the base portion 110 of the non-metal component 102 and an edge 147 of the metal component 106. In accordance with one aspect, the axial gap 144 may have a dimension between edges 146, 147 of about 0.01 inches or less. The presence of the axial gap 144 may further accommodate differential rates of thermal expansion between the metal component 106 and the non-metal component 102.

The first fastening device 118 and the second fastening device 126 may comprise any suitable structure(s) configured to secure the first segment 108 and the second segment 120 in their desired positions. In accordance with one aspect and referring again to FIG. 2, the first fastening device 118 may comprise a first threaded bolt 148 (first bolt 148) that extends through the non-metal component 102 and the base portion 110. In addition, the first fastening device 118 may further include a nut 150 which is arranged to secure the first bolt 148 at a distal end 152 thereof to fix the first bolt 148 in a desired position. Similarly, the second fastening device 126 may comprise a second threaded bolt 154 (second bolt 154) that extends through the metal component 106 and the second segment 120, and a second nut 156 arranged to secure threads of the second bolt 154 at a distal end 158 thereof to secure the first extent 112 between the locking flange 122 and the metal component 106. Alternatively, any other suitable fastening structure(s) may be utilized in the system 100 for the first and second fastening devices. In certain embodiments, the non-metal component may comprise a recessed portion 149 as illustrated for receiving the first bolt 148, although it is appreciated that the present invention is not so limited.

Since the components of the fastening devices may be formed from a metal material, cooling of the fasteners may be desired. Thus, in certain embodiments, as shown in FIG. 5, the first bolt 148 and/or the second bolt 154 may comprise at least one cooling channel 160 extending there through to assist in the cooling of the associated bolt and immediate area. The cooling channel 160 may be in fluid contact with a suitable liquid or gas source for delivering a cooling fluid 162, e.g., air, through the cooling channel 160.

As mentioned, the arrangements and systems described herein may accommodate the differential rates of thermal expansion of the non-metal component 102 and the metal component 106 via at least the presence of the radial gap 128, and optionally also the axial gap 144. In accordance with another aspect of the present invention, any two or more of the structures described herein may have complementary curved surfaces to also allow for a degree of angular translation of the non-metal component 102 relative to the metal component 106. In this way, the curved surfaces may allow the non-metal component 102 (e.g., CMC transition duct 130) to be rotated relative to the metal component 106 (e.g., mating flange 132 of the IEP 134) to provide angular and radial fit-up with the combustor as is necessary.

Referring now to FIG. 6, there is shown another embodiment of a system 100A in accordance with an aspect of the present invention. The components of system 100A may be the same as in system 100 except the components may further include curved surfaces as explained below. By way of example in FIG. 6, the non-metal component 102A, metal component 106A, a first segment 108A, and second segment 120A each include curved surfaces, each of which is complementary to the curved surface of its abutting structure. In addition, a first surface 164 of locking flange 122A and a first surface 166 of the first extent 112A may comprise complementary curved surfaces in abutting relationship with one another. Further, an opposite surface 172 of the first extent 112A and a surface 174 of the metal component 106A may comprise complementary curved surfaces. In an embodiment, both a base portion 110A and the first extent 112A of the first segment 108A have a curved surface. Still further, the non-metal component 102A comprising a CMC material 104 and the metal component 106A may have complementary curved surfaces as shown.

Prior to and/or following securement of the fastening devices 118, 126 in their desired position, the presence of the curved surfaces may enable slidable movement of the components 102A, 106A relative to one another. This may be suitable for adjustment of the components 102A, 106A during installation and/or allow for slidable movement of the components 102A, 106A due to mechanical stresses and/or differing thermal expansion rates between the components 102A, 106A. In one aspect, the first extent 112A may have a degree of freedom of movement within the radial gap 128 in the direction of double arrow 180 as upon application, for example. In another aspect, the presence of the curved surfaces may also allow for angular translation of the non-metal component 102A relative to the metal component 106A as shown by double arrow 182. In an embodiment, the degree of angular translation is greater than 0°, but less than or equal to 2°.

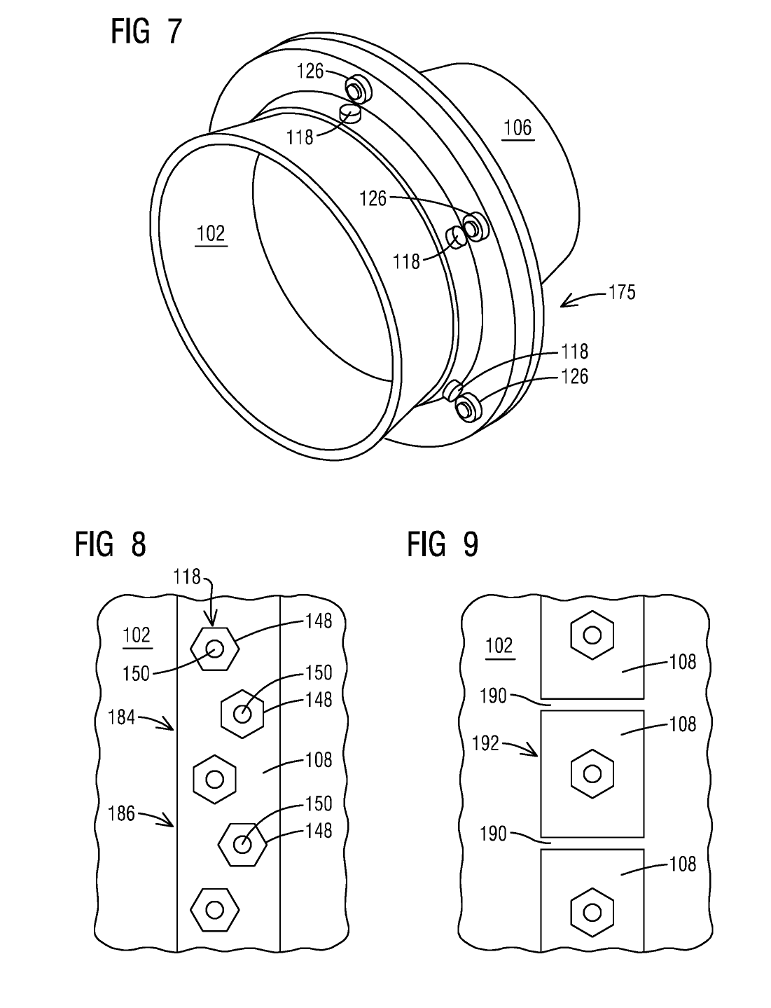

For ease of explanation, FIGS. 2 and 6 illustrated a cross-section of single connection system 100, 100A in accordance with aspects of the present invention at a single location. However, in order to fully secure a non-metal component to a metal component as described herein, it is appreciated that the components may be required to be secured to one another at a plurality of locations. By way of example only, the non-metal component 102, 102A, metal component 106, 106A, first segment 108, 108A, and second segment 120, 120A may each be at least partially cylindrical in shape, and may have a body portion that extends through a full 360 degrees. Referring to FIG. 7, for example, first and second fastening devices 118, 126 may be located at various spaced apart locations about a circumference 175 of the components 102, 106 to secure the first segment 108 to the non-metal component 102 and to secure the first extent 112 between the locking flange 122 and the metal component 106 as described previously herein. It is understood that at each location where there are located fastening devices 118, 126 may be considered to define a system 100, 100A as described herein. Thus, in one aspect, there may be employed multiple systems 100, 100A to attach a non-metal component 102, 102A comprising a CMC material 104 to a metal component 106, 106A. Moreover, in certain embodiments, the components described herein may have a continuous body about its circumference. Alternatively, any of the components may comprise a segmented body having gaps therebetween about its circumference.

In another aspect, there may be provided a plurality of systems (100, 100A) as described herein wherein one or both of the fastening devices are provided in a staggered relationship about a circumference of the components. By way of example only, as shown in FIG. 8, a plurality of the first bolts 148 and corresponding nuts 150 (collectively first fastening device 118) for securing the first segment 108 to the base portion 110 as described herein may be disposed in a staggered pattern 184 about a circumference 186 of the first segment 108 and the non-metal component 102 to secure the first segment 108 to the non-metal component 102. In the embodiment shown in FIG. 8, there is shown a two-dimensional flattened top view of the circumference of a first segment 108 at various locations about the circumference 186 of the first segment 108 for ease of illustration. In certain embodiments, the staggered system may provide for better attachment strength and may counter any overturning moment loading on the first segments 108. As mentioned, any of the components described herein may comprise a segmented body having gaps therebetween about its circumference. Referring to FIG. 9, for example, a plurality of first segments 108 may be provided having gaps 190 therebetween about a circumference 192 of the non-metal component 102 to allow for further thermal growth of the ceramic matrix composite material 104.

The present disclosure further includes processes for forming and using the above claimed systems. In accordance with another aspect, there is thus provided a method for attachment of a non-metal component 102, 102A to a metal component 106, 106A comprising:

providing a non-metal component 102, 102A including a ceramic matrix composite material 104, wherein the non-metal component 102, 102A comprises a transition duct 130 for a gas turbine engine 5;

providing a metal component 106, 106A, wherein the metal component 106, 106A comprises a metallic mating flange 132 for an individual exit piece 134 of the gas turbine engine 5;

providing a first segment 108, 108A having a base portion 110 and a first extent 112, 112A extending radially from the base portion 110, 110A;

providing a second segment 120, 120A comprising a locking flange 122, 122A;

positioning the first segment 112, 112A such that the base portion 110 abuts the non-metal component 102, 102A and the first extent 112, 112A abuts the metal component 106, 106A;

further positioning the first extent 112, 112A between the locking flange 122, 122A and the metal component 106, 106A;

securing the base portion 110 to the non-metal component 102, 102A;

securing the first extent 112, 112A between the locking flange 122, 122A and the metal component 106, 106A; and

disposing a radial gap 128 between the first extent 112, 112A and the locking flange 122, 122A to accommodate different rates of thermal expansion between the non-metal 102, 102A and metal components 106, 106A.

While various embodiments of the present invention have been shown and described herein, it will be obvious that such embodiments are provided by way of example only. Numerous variations, changes and substitutions may be made without departing from the invention herein. Accordingly, it is intended that the invention be limited only by the spirit and scope of the appended claims.

1. An attachment system for attaching a non-metal component to a metal component comprising:
a non-metal component including a ceramic matrix composite material, wherein the non-metal component comprises a transition duct for a gas turbine engine;
a metal component, wherein the metal component comprises a metallic mating flange for an individual exit piece of the gas turbine engine;
a first segment having a base portion arranged to abut a surface of the non-metal component and a first extent extending radially from the base portion, the first extent arranged to abut a surface of the metal component;
a second segment comprising a locking flange, wherein the first extent of the first segment is arranged between the locking flange of the second segment and the metal component;
a first fastening device arranged to secure the base portion to the non-metal component;
a second fastening device arranged to secure the first extent between the locking flange and the metal component; and
a radial gap disposed between the first extent and the locking flange to accommodate different rates of thermal expansion between the non-metal and metal components.

2. The system of claim 1, wherein the radial gap has a dimension of about 0.15 inches or less.

3. The system of claim 1, wherein the first fastening device comprises a first threaded bolt that extends through the non-metal component and the base portion, and a nut arranged to secure the first threaded bolt at a distal end thereof.

4. The system of claim 3, wherein the first bolt comprises a cooling channel extending therethrough.

5. The system of claim 1, wherein the second fastening device comprises a second threaded bolt that extends through the metal component and the second segment, and a nut arranged to secure the second threaded bolt at a distal end thereof to secure the first extent between the locking flange and the metal component.

6. The system of claim 1, further comprising an axial gap disposed between the base portion of the first segment and the metal component.

7. The system of claim 1, wherein the locking flange and the first extent comprise complementary curved surfaces.

8. The system of claim 7, wherein first extent and the base portion of the first segment comprise complementary curved surfaces with a surface of the metal component.

9. The system in of claim 7, wherein the system is configured to allow for a degree of angular translation of the non-metal component relative to the metal component.

10. The system of claim 9, wherein the degree of angular translation is greater than 0° but less than 2°.

11. The system of claim 1, wherein the non-metal component, the metal component, the first segment, and the second segment each include a cylindrical portion, and wherein a plurality of first fastening devices and the second fastening devices are disposed about a circumference of the non-metal component, the metal component, the first segment, and the second segment to secure the non-metal component to the metal component.

12. The system of claim 11, wherein a plurality of first fastening devices and second fastening devices are disposed in a staggered spaced apart relationship about a circumference of the metal component and the non-metal component.

13. The system of claim 12, wherein a plurality of spaced apart first segments having gaps therebetween) are provided about a circumference of the non-metal component.

14. A gas turbine engine incorporating the system of claim 1.

15. A method for attachment of a non-metal component to a metal component comprising:
providing a non-metal component including a ceramic matrix composite material, wherein the non-metal component comprises a transition duct for a gas turbine engine;
providing a metal component, wherein the metal component comprises a metallic mating flange for an individual exit piece of the gas turbine engine;
providing a first segment having a base portion and a first extent extending radially from the base portion;
providing a second segment comprising a locking flange;
positioning the first segment such that the base portion abuts the non-metal component and the first extent abuts the metal component;
further positioning the first extent between the locking flange and the metal component;
securing the base portion to the non-metal component;
securing the first extent between the locking flange and the metal component; and
disposing a radial gap between the first extent and the locking flange to accommodate different rates of thermal expansion between the non-metal and metal components.

16. The method of claim 15, wherein the securing the base portion to the non-metal component is done via positioning a first threaded bolt through the non-metal component and the base portion, and securing the first threaded bolt at an end thereof.

17. The method of claim 15, wherein securing the first extent between the locking flange and the metal component comprises positioning a second bolt through the metal component and the second segment, and securing the second bolt at an end thereof.

18. The method of claim 15, further comprising disposing an axial gap between the base portion and the metal component.

19. The method of claim 15, wherein the locking flange and the first extent comprise complementary curved surfaces.

20. The method of claim 15, wherein first extent and the base portion of the first segment comprise complementary curved surfaces.

21. The method of claim 15, further comprising providing a degree of angular translation of the non-metal component relative to the metal component.

22. The method of claim 21, wherein the degree of angular translation is greater than 0° but less than 2°.

23. The method of claim 15, further comprising securing the base portion to the non-metal component and securing the first extent between the locking flange and the metal component at a plurality of locations about a circumference of the non-metal component and the metal component to secure the non-metal component to the metal component.
